(19) United States
(12) Patent Application Publication
(10) Pub. No.: US 2024/0147988 A1
(43) Pub. Date: May 9, 2024

(54) LIQUID PESTICIDE COMPOSITION CONTAINING NANO-BUBBLES AND METHOD OF USE THEREOF

(71) Applicant: Greaux Alliance, LLC, Sicily Island, LA (US)

(72) Inventors: John Patrick Chapman, Fairhope, AL (US); Peter Grosso, Gulf Shores, AL (US)

(21) Appl. No.: 18/275,002

(22) PCT Filed: Aug. 25, 2022
(86) PCT No.: PCT/US22/41597

§ 371 Date: Jul. 29, 2023

Related U.S. Application Data
(60) Provisional application No. 63/237,062, filed on Aug. 25, 2021.

(51) Int. Cl. A01N 25/04; A01N 25/28; A01N 59/00; A01P 21/00

(52) U.S. Cl. CPC A01N 25/04; A01N 25/28; A01N 59/00; A01P 21/00

(57) ABSTRACT

Liquid pesticide compositions and methods of making and using the compositions for crop protection from pests are provided. A liquid pesticide formulated to control crop pests is infused with nano-bubbles that increase the efficacy of the liquid pesticide. The liquid pesticide may be mixed and homogenized before flowing the liquid pesticide through a nano-bubble generator. The liquid pesticide may be mixed and prepared for packaging or mixed in-situ for direct application to crops. The liquid pesticide composition infused with nano-bubbles may be applied to both crops and soil in the same manner as standard liquid pesticides to control pests for crop protection.

### CROSS REFERENCES

This application is a national stage application of International Patent Application No. PCT/US2022/041597, filed on Aug. 25, 2022, which claims the benefit of U.S. Provisional Application No. 63/237,062, filed on Aug. 25, 2021, which applications are incorporated herein in their entirety by reference.

### FIELD OF THE DISCLOSURE

The subject matter of the present disclosure refers generally to liquid pesticide compositions and methods of making and using such compositions for treating crops.

### BACKGROUND

There are many different types of pesticides that are utilized commercially for controlling many different types of pests, such as insects, rodents or other types of animals, weeds, bacteria, microbes, or fungi, among many other pests. The term “pesticide” may broadly encompass a wide variety of substances or mixtures of substances used to kill or to otherwise control the growth or spread of a wide variety of different types of target pests. The active ingredient or ingredients of a pesticide may be chemical or biological in nature. Pesticides used commercially for crop protection may be applied to crop fields in either solid or liquid formulations and are typically formulated to control specific types of pests that would harm crops and reduce crop yield if left untreated. Such pests that are particularly harmful to crops commonly include insects, weeds, fungi, and nematodes, among others. Liquid pesticide formulations applied to crops generally provide a more rapid effect and easier coverage compared to solid pesticides. Liquid formulations of such pesticides may be applied directly to the leaf tissue of crop plants and/or to the soil in which crops are grown. Most liquid crop protection pesticides are typically applied broadly to both plant and soil in a single application. Liquid pesticides may be applied by a sprayer, such as a portable sprayer that is manually operated or a self-propelled sprayer, or through irrigation systems. Liquid pesticide applied directly to crop plants, such as herbicides, may be absorbed directly into the plant tissue, and liquid pesticide applied to the soil, such as fungicides, may permeate the soil so that the plant roots take up the active ingredient(s) contained in a liquid carrier or solvent. Liquid pesticides may also be applied to the soil in a subsurface application.

Because liquid pesticides used for commercial crop protection are typically applied broadly in a single application to minimize both the time and costs of pesticide application, such application generally uses excess pesticide to ensure adequate coverage. Thus, it would be advantageous to provide liquid pesticides having increased efficacy compared to currently known liquid pesticides, as well as methods of making and using such liquid pesticide compositions for crop protection.

### SUMMARY

In one aspect, a liquid pesticide composition is provided. The composition comprises a liquid pesticide formulated for crop protection to manage one or more types of pests, such as insects, weeds, bacteria, or fungi, that may adversely affect crop growth and yield. The liquid pesticide composition has nano-bubbles dispersed within the liquid pesticide. The liquid pesticide may be formulated to control different types of pests by various mechanisms, which may include chemical or biological modes of action. The nano-bubbles may include molecular oxygen (O₂), which may be provided from a pure oxygen source or from compressed air, or ozone (O₃). The nano-bubbles preferably have a mean diameter of less than 500 nanometers. The liquid pesticide composition preferably has greater than one billion nano-bubbles per milliliter of liquid pesticide dispersed in the liquid pesticide. The nano-bubbles are transferred into the liquid pesticide so that the nano-bubbles are dispersed throughout a liquid carrier or solvent in which the active ingredients of the pesticide are mixed or dissolved. Nano-bubbles are neutrally buoyant and can therefore remain suspended in the liquid pesticide for an extended period of time after final packaging of the liquid product to allow for the product to be transported to an end user and to allow for an adequate shelf life before use. Alternatively, nan-bubbles may be transferred into a liquid pesticide in-situ in the field as the liquid pesticide is applied to crops.

The nano-bubbles dissolved in the liquid pesticide composition may increase the efficiency and efficacy of the pesticide to control pests and thus may also increase crop yield. Nano-bubbles may be added to various types of liquid pesticides that are formulated to control specific types of pests in order to increase the efficiency and efficacy of the liquid pesticide. Nano-bubbles present in the liquid pesticide reduce the viscosity of the liquid carrier or solvent, which may contain suspended or dissolved particles of the active ingredient of the specific pesticide formulation. Reducing the viscosity of the liquid helps to achieve better coverage of the liquid onto the leaf tissue of crop plants. The reduced viscosity of a liquid pesticide in which nano-bubbles have been dispersed may also increase the speed of entry of active ingredients into the plant cuticle as well as the speed of plant uptake, thereby increasing the speed of biological activity of the active ingredients for crop protection. Soil mobility after application may also be enhanced. Increased speed of activity of crop protection components is generally beneficial to crops and may also shorten the amount of time required between application of the pesticide and exposure to rain and/or irrigation, thereby enhancing the rainfast characteristics of the active ingredients of the pesticide. A liquid pesticide in which nano-bubbles have been dispersed may also achieve an increase in efficacy because the presence of dispersed nano-bubbles in the liquid carrier or solvent may increase the ease of mixing chemicals, which aids in liquid handling and application. The presence of nano-bubbles may also act to stabilize the liquid pesticide formulation by helping to keep active ingredients of the pesticide suspended or dissolved in the liquid carrier or solvent. In addition, nano-bubbles present in the liquid may reduce antagonism between ingredients of the liquid pesticide due to enhanced ionic balance. Thus, nano-bubbles dispersed within a liquid pesticide may provide a variety of benefits that further enhance the crop protection characteristics of a specific pesticide.

In another aspect, methods of producing a liquid pesticide composition and of utilizing the liquid composition to treat crops are provided. First, a liquid pesticide formulated for controlling one or more types of pest is provided. The liquid pesticide may include a variety of different liquid pesticide formulations in which nano-bubbles may be dissolved into a liquid carrier or solvent. Nano-bubbles may then be transferred into the liquid pesticide so that the nano-bubbles are dispersed throughout the liquid pesticide formulation. The nano-bubbles may include oxygen and nitrogen nano-bubbles derived form a source of compressed air. Alternatively, the nano-bubbles transferred into the liquid pesticide may be derived from sources of pure oxygen, ozone, or nitrogen, or may include other gases, such as gases that may be beneficial to plant growth, such as ammonia, ammonium gases, or nitrate gases.

To produce the liquid pesticide composition with nano-bubbles, the nano-bubbles may preferably be transferred into the liquid formulation as a final step in the process before final packaging of the liquid pesticide for transport and sale to an end user, or, alternatively, the nan-bubbles may be transferred into the liquid formulation in-situ as the liquid pesticide is being applied. When preparing the liquid formulation for packaging, transferring the nano-bubbles is preferably the final step so that other steps in the process do not cause some of the nano-bubbles dissolved in the liquid to come out of solution and thus decrease the concentration of nano-bubbles, which would reduce the efficacy of the liquid pesticide formulation. The liquid pesticide to which the nano-bubbles are to be added may include any liquid substance that directly acts as a pesticide or may be formulated by adding any solid or additional liquid pesticide compounds to a liquid carrier or solvent and mixing or dissolving the pesticide compounds in the liquid carrier. After addition of active liquid or solid pesticide ingredients, the liquid pesticide may be run through a static mixer and a high shear pump to homogenize the liquid pesticide mixture or solution. Once the liquid pesticide formulation is adequately mixed and homogenized, nano-bubbles may be introduced to infuse the liquid with nano-bubbles. To this end, the liquid pesticide may be run through a nano-bubble generator before final packaging of the liquid product. The production system may be designed for a single pass through the nano-bubble generator or, optionally, for multiple passes to increase the concentration of nano-bubbles in the liquid product. The nano-bubble generator may transfer nano-bubbles into the liquid pesticide formulation by osmosis, or, alternatively, other methods of introducing nano-bubbles into a liquid may be utilized, such as high-pressure dissolution, ejectors, venturi tubes, supersonic vibration, or swirl flow technology. Once the nano-bubbles have been dissolved into and dispersed within the liquid, the liquid pesticide containing the nano-bubbles may be applied directly onto crops and to soil in which the crops are grown in the same manner as any other liquid pesticide. For instance, the liquid pesticide may be applied broadly to both crops and to the surface of the soil. Alternatively, the liquid pesticide may also be applied subsurface. The liquid pesticide may also be optionally used in fallow applications to maintain crop fields for later planting. Liquid pesticides may be applied by any suitable type of sprayer, which may include portable sprayers that are manually operated, trailed sprayers that are hauled behind a tractor or other vehicle, or self-propelled sprayers. Liquid pesticides may also be applied using irrigation systems, such as sprinklers, drip irrigation systems, or other suitable types of irrigation systems.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 shows a schematic view of a system that may be utilized to produce a liquid pesticide composition having nano-bubbles dispersed in the liquid pesticide in accordance with the present disclosure.

FIG. 2 shows a schematic view of a system that may be utilized to produce a liquid pesticide composition having nano-bubbles dispersed in the liquid pesticide in-situ as the pesticide is applied to crops in the field in accordance with the present disclosure.

FIG. 3 is a chart showing an average percentage of weed control at 16 days after treatment for two types of weeds treated with an herbicide mixed with non-treated water and with nano-bubble treated water at two herbicide concentrations.

FIG. 4 is a chart showing an average percentage of weed control at 16 days after treatment for two types of weeds treated with an herbicide mixed with non-treated water and with nano-bubble treated water at two herbicide concentrations.

FIG. 5 is a chart showing an average percentage of weed control at 16 days after treatment for two types of weeds treated with an herbicide mixed with non-treated water and with nano-bubble treated water at two herbicide concentrations.

FIG. 6 is a chart showing a response of bacteria treated with a bactericide mixed with nano-bubble treated water at varying bactericide concentrations.

FIG. 7 is a chart showing a response of control samples of bacteria treated with a bactericide mixed with deionized water at varying bactericide concentrations.

FIG. 8 is a chart showing a response of bacteria treated with a bactericide mixed with nano-bubble treated water at varying bactericide concentrations.

FIG. 9 is a chart showing a response of control samples of bacteria treated with a bactericide mixed with deionized water at varying bactericide concentrations.

### DETAILED DESCRIPTION

The present disclosure provides a liquid pesticide composition and methods for making the composition and using the composition for treating agricultural fields in which crops are grown in accordance with the independent claims. Preferred embodiments of the claimed invention are reflected in the dependent claims. The claimed invention can be better understood in view of the embodiments described and illustrated in the present disclosure, including the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

In the Summary above and in this Detailed Description, and the claims below, and in the accompanying drawings, reference is made to particular features, including method steps, of the invention as claimed. In the present disclosure, many features are described as being optional, e.g. through the use of the verb “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features. It is to be understood that the disclosure in this specification includes all possible combinations of such particular features. For example, where a particular feature is disclosed in the context of a particular aspect or embodiment, or a particular claim, that feature can also be used, to the extent possible, in combination with/or in the context of other particular aspects or embodiments, and generally in the invention as claimed.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As used herein, the term “nano-bubble” refers to a bubble having a diameter of 1,000 nanometers (nm), equal to one micron, or less. A micro-bubble is a bubble that has a diameter of larger than one micron and up to 100,000 nm. An ultrafine bubble has a diameter larger than 100,000 nm and up to 3,000,000 nm. A coarse bubble is any bubble larger than an ultrafine bubble.

As used herein, the term “liquid pesticide” refers to any liquid substance, composition, formulation, solution, mixture, emulsion, or colloid that may be used to control pests for crop protection. As such, liquid pesticides may include any substance, chemical, composition, or compound that kills or otherwise regulates, prevents, or discourages the growth or the spread of any type of pest that is harmful to crops, such as commonly used crop protection pesticides used to protect crop plants from common pests such as insects, weeds, bacteria, and fungi. Liquid pesticides may also include liquid adjuvants formulated to enhance the effectiveness of pesticide formulations applied to crops. Liquid pesticides may include any pure liquid substance that acts directly as a pesticide itself, or may include pesticide compounds suspended or dissolved in a liquid carrier or solvent. Liquid pesticides may also include pesticide compositions in the form of an emulsion or colloid. The liquid carrier or solvent may include water, an organic solvent, or any other liquid carrier or solvent suitable for dissolving or mixing with an active ingredient of a pesticide. Liquid pesticide formulations may be in concentrated or diluted formulations. Depending on the active ingredients, the biological activity of the liquid pesticide may be chemical or biological in nature.

As used herein, the term “liquid pesticide” may include, but is not limited to, insecticides, herbicides, fungicides, nematicides, molluscicides, bactericides, algaecides, or antimicrobials. Liquid pesticides may also include biopesticides, which may include microbial pesticides, pesticides with bio-derived chemicals, or any other type of pesticide that includes a biological agent, such as a virus, a bacterium, or a fungus. Liquid formulations of chemical pesticides may include any chemical active ingredient suitable for pest control, including, but not limited to, glyphosate, carbamates, organophosphates, organochlorines, or copper hydroxide. Active ingredient chemicals may be in the form of granules, microgranules, dust, or soluble or wettable powder, which may be dissolved, suspended, or mixed with the liquid carrier or solvent. Liquid pesticides may also include plant-derived pesticides commonly referred to as “botanicals.” Liquid pesticides may also be specifically formulated for application to field crops and soil, for post-harvest application to crop plants, or for fallow application to fields in which crops are not currently planted.

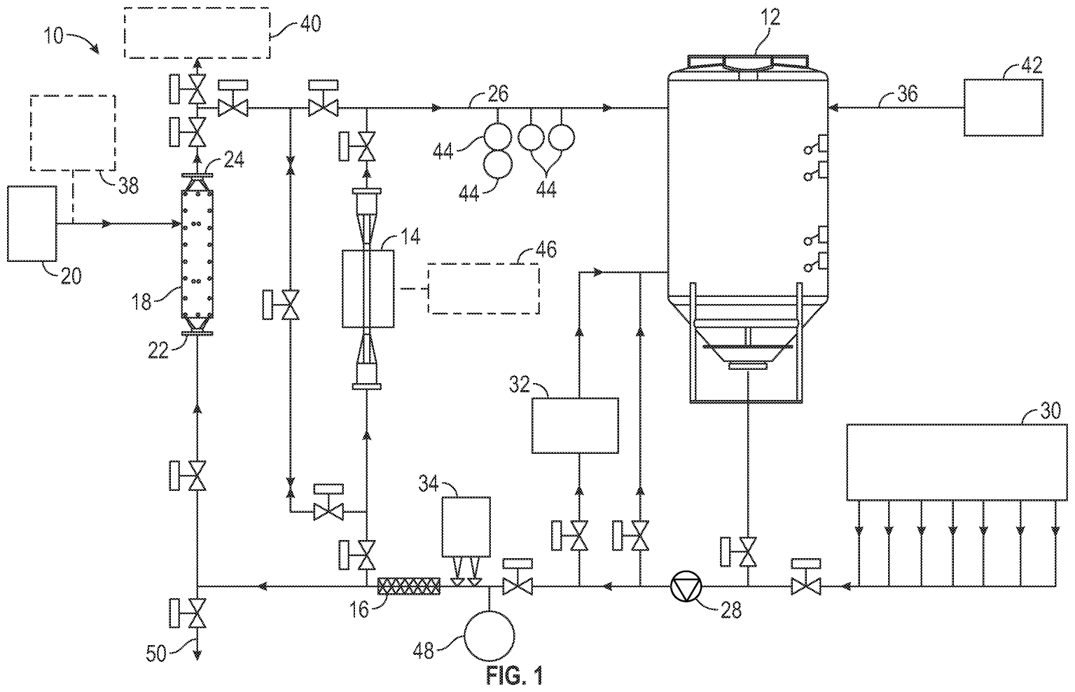

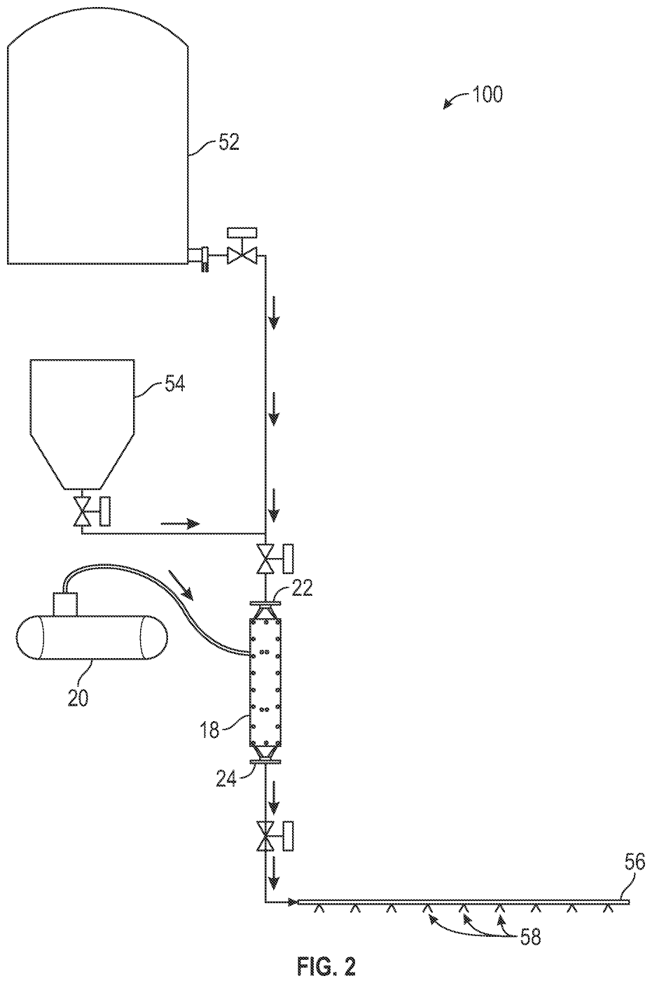

FIGS. 1 and 2 illustrate systems that may be used for the production of a liquid pesticide formulation that contains nano-bubbles dispersed within the liquid pesticide. FIG. 1 illustrates a system 10 that may be used to produce liquid pesticide for packaging for later use, and FIG. 2 illustrates a system 100 that may be used to produce liquid pesticide in-situ for immediate application. The system 10 shown in FIG. 1 includes a nano-bubble gas generator 18 and preferably also includes a high shear pump 14 and a static mixer 16. The nano-bubble generator 18 has a liquid pesticide inlet 22 and a liquid pesticide outlet 24, which is the output of the final liquid pesticide product containing nano-bubbles dispersed within the liquid, which is transferred directly from the nano-bubble generator 18 to final packaging 40 of the liquid pesticide product for delivery to an end user. The nano-bubble generator 18 may transfer nano-bubbles into the liquid via osmosis and may comprise a ceramic media for gas transfer or any suitable type of semipermeable membrane. Alternatively, the nano-bubble generator 18 may transfer nano-bubbles into the liquid by other gas injection processes, such as high-pressure dissolution, ejectors, venturi tubes, supersonic vibration, or swirl flow technology. The nano-bubble generator 18 includes a gas source 20 for supplying a gas from which nano-bubbles may be infused into the liquid pesticide formulation. The gas source 20 may be a compressed air source. Alternatively, the gas source 20 may supply pure oxygen (O₂), ozone (O₃), or nitrogen (N₂), or may supply other gases such as ammonia, ammonium gases, or nitrate gases. Multiple gas sources 20 may optionally be utilized with one or more nano-bubble generators 18 to supply nano-bubbles of more than one type of gas to a single liquid pesticide stream. The liquid pesticide formulation may preferably comprise a liquid pesticide that includes at least dissolved oxygen (O₂) nano-bubbles dispersed in the liquid.

The system 10 may include a large mixing tank 12 for holding and mixing liquid pesticide formulations. The mixing tank 12 has a liquid fill line 36 for adding a liquid into the mixing tank 12 from a source 42. The liquid added may be a pre-mixed liquid pesticide product added directly to the tank 12 or a liquid carrier to which additional pesticide compounds or substances will be added. The system 10 may have subsystems for adding solid or liquid pesticide compounds to a liquid pesticide and for mixing liquid pesticide formulations. For instance, the system 10 may have a plurality of feed lines 30 that may be utilized for adding various ingredients, which may include active or inactive ingredients, into the system 10 to produce a specific pesticide formulation and to provide flexibility for producing different types of pesticide formulations at any given time. The feed lines 30 may be utilized to add a variety of different types of liquid ingredients into the system 10 to produce any type of pesticide formulation, including liquid mixtures, solutions, emulsions, or colloids. The system 10 may have a circulation pump 28 for circulating liquid streams from the mixing tank 12 either back to the tank 12 or to final packaging 40 of the finished liquid pesticide product for an end user. The system 10 may also include an eductor injection system 32 for injecting solid compositions into a liquid carrier, which may include active or inactive ingredients for the pesticide, which may be in the form of granules, microgranules, dust, soluble powder, wettable powder, or other similar types of solid compositions. The system 10 may also include one or more injection pumps 34 for injecting any additional liquid compositions into the liquid stream to produce a desired pesticide product. Thus, the system 10 may allow for the production of a variety of different formulations of liquid pesticide solutions for various crop protection applications.

For instance, the system 10 may be utilized to produce liquid crop protection pesticides such as herbicides, which may be selective or non-selective herbicides, insecticides, which may be contact or systemic insecticides, fungicides, which may be contact, systemic, or translaminar fungicides, bactericides, algaecides, and biopesticides. Alternatively, the system 10 may be utilized for treating a pre-mixed liquid pesticide product, which may include commercially available liquid pesticides, with nano-bubbles before final packaging 40 or application to crops. Pre-mixed pesticide products may be ready-to-use formulations or concentrated formulations to which water or solvents may be added to produce a liquid pesticide having desired concentrations of active ingredients. The liquid fill line 36 may be utilized to add both pesticide formulations and water or solvents, or optionally additional lines may be installed for different liquid components. During or after formulation of the liquid pesticide, the circulation pump 28 may be used to circulate the liquid pesticide stream and help to mix the various components of the stream. The circulation pump 28 may be used to circulate the liquid pesticide stream through a static mixer 16 to further aid mixing of the stream, as well as through a high shear pump 14 downstream of the static mixer 16 for further mixing and particle size reduction, particularly of solid pesticide compounds injected into the liquid stream. All solid and liquid components of the pesticide formulation are preferably added to the liquid stream before running the liquid pesticide through the high shear pump 14. The system 10 preferably includes a recirculation line 26 for recirculating the liquid stream through the high shear pump 14 back to the mixing tank 12. The system may include various instruments 44, which may be installed on the recirculation line 26, to measure properties of the liquid stream, such as pH, dissolved oxygen, temperature, and salinity. The liquid stream may be recirculated as necessary to formulate the liquid pesticide before the addition of nano-bubbles to the liquid stream. The system 10 may include a flow meter 48 to measure liquid flow. The formulated liquid pesticide may also be optionally run through one or more filters, such as 150 mesh bag filters, to remove any material not in solution before the addition of nano-bubbles. The system 10 may include a liquid drain line 50 for draining liquid from various lines of the system.

The system 10 includes a nano-bubble generator 18 for transferring nano-bubbles into the liquid pesticide stream. The liquid pesticide stream may be conveyed through the nano-bubble generator 18 after flowing through the shear pump 14 and as the final step of the production process before final packaging 40 of the liquid pesticide for an end user. The addition of nano-bubbles to the liquid stream by flowing the liquid stream through the nano-bubble generator 18 may be the final step of the production process so as to maximize the nano-bubble concentration in the liquid pesticide formulation. Performing other processes on the liquid stream, such as running the liquid stream through the high shear pump 14, after the addition of nano-bubbles may decrease the concentration of nano-bubbles in the final product. Thus, addition of nano-bubbles in the final step maximizes both nano-bubble concentration and also the time in which nano-bubbles will remain in suspension in the liquid, which allows time for the product to be transported to the end user and for an adequate shelf life before use. The neutral buoyancy and negative surface charge of the nano-bubbles typically allows the nano-bubbles to remain in suspension for an extended period of time lasting up to a year or more. Thus, the liquid pesticide composition will retain its efficacy for a longer period of time when nano-bubble infusion is the final step before final packaging 40.

As shown in FIG. 1, the nano-bubble generator 18 may preferably be arranged in parallel with the high shear pump 14, which may be operated via a control panel 46 configured to control operation of the pump 14. In this arrangement, the liquid pesticide stream may be recirculated through the high shear pump 14 until all components are sufficiently mixed into a homogenous mixture, solution, or stable emulsion, at which point the stream may be conveyed through the nano-bubble generator 18 using the circulation pump 28. As the liquid pesticide stream flows through the nano-bubble generator 18, nano-bubbles are transferred into the liquid stream such that the liquid becomes infused with nano-bubbles that are dispersed throughout the liquid. Alternatively, the nano-bubble generator 18 may be arranged in series with the high shear pump 14, preferably downstream of the pump 14. The liquid stream may be conveyed through the nano-bubble generator 18 only once before packaging 40 or may make multiple passes through the nano-bubble generator 18 using the recirculation line 26 and bypassing the high shear pump 14 to increase the concentration of nano-bubbles in the liquid. The rate of transfer of nano-bubbles into the liquid may be controlled by a gas feed control panel 38 configured to control a gas flow rate from the gas source 20 to the nano-bubble generator 18. The dissolved oxygen meter or other instruments 44 may be utilized to measure the gas content of the liquid stream to reach a desired nano-bubble concentration in the liquid pesticide composition before transferring the liquid to final packaging 40. The system 10 may optionally include additional mixing tanks 12 for transferring different formulations of pesticide between tanks for maximum flexibility in mixing and formulating pesticides. It should be understood that the system 10 shown in FIG. 1 is an illustrative system 10 that may be utilized to produce a liquid pesticide formulation with nano-bubbles and that the system may have different configurations of the system components and still fall within the scope of the present disclosure.

In the system 100 shown in FIG. 2, the liquid pesticide formulation with nano-bubbles may be produced in-situ for immediate application. As shown in FIG. 2, the system 100 may include a water supply tank 52, a liquid pesticide supply tank 54, a compressed gas source 20, and a nano-bubble generator 18 having a liquid pesticide inlet 22 and a liquid pesticide outlet 24. The liquid pesticide supply tank 54 may contain a concentrated liquid pesticide that is mixed in-situ with water from the water supply tank 52 to produce a liquid pesticide composition having a desired concentration of active pesticide ingredients. The liquid pesticide composition may then flow through the nano-bubble generator 18 to produce a liquid pesticide formulation with nano-bubbles in-situ. Alternatively, a pre-formulated liquid pesticide composition may be loaded into tank 52 for in-situ production of the formulation with nano-bubbles, or a solvent or carrier other than water may be utilized. The system 100 may further include a field spray unit 56, which may comprise a spray bar or boom having a plurality of spray nozzles 58 disposed along a length of the boom for applying the liquid herbicide to crops and/or fields. The system 100 may be installed on a tractor or other vehicle or on a trailer that may be pulled by a vehicle so that the system 100 may be utilized as a self-propelled sprayer or a trailed sprayer. In-situ production directly on the sprayer allows application of the liquid pesticide immediately upon transfer of nano-bubbled into the liquid.

Once transferred into the liquid pesticide, the dissolved nano-bubbles preferably have a mean diameter of less than 500 nm, and more preferably a mean diameter less than 200 nm. In general, the smaller the diameter of the nano-bubbles, the greater the efficacy of the liquid pesticide composition. The nano-bubble generator 18 may produce nano-bubbles having a mean diameter of less than 100 nm. In preparations of liquid pesticide formulations infused with nano-bubbles, a nano-bubble generator 18 sold under the trademark XTBi™ Nanobubble Generator by Moleaer® Inc. and having a maximum liquid flow rate of 500 gallons per minute (gpm) may be utilized to add nano-bubbles to various liquid pesticides to achieve desired nano-bubble concentrations and mean size. This model of nano-bubble generator generally produces nano-bubbles having a mean diameter of smaller than 100 nm. When adding compressed ambient air to a liquid pesticide in a single pass through the nano-bubble generator 18, preferably at least 2 ppm by volume of molecular oxygen (O₂) may be added to the liquid pesticide, depending on the properties of the specific liquid carrier or solvent. In production of various formulations of liquid pesticide compositions using the nano-bubble generator 18, a single pass with ambient air may result in an increase in oxygen concentration of about 2-4 parts per million (ppm) oxygen by volume, depending on the liquid carrier or solvent, and multiple passes with ambient air may result in an increase in oxygen concentration of up to 9 ppm by volume by recirculating the liquid stream through the nano-bubble generator 18. Using a 2,000 gallon mixing tank 12, an increase in oxygen concentration in the liquid pesticide stream of up to at least 7-9 ppm by volume may be achieved by recirculating the liquid pesticide about three to four times through the nano-bubble generator 18 using compressed air as the gas source 20, depending on the liquid properties and flow rate. When adding pure oxygen (O₂) rather than air, preferably up to 10 ppm by volume of molecular oxygen may be added to the liquid pesticide in a single pass through the nano-bubble generator 18. Liquid pesticide formulations treated with nano-bubbles in accordance with the present method were observed to have a decrease in liquid viscosity and surface tension as well as overall improved liquid handling characteristics.

Although smaller nano-bubbles are preferable, the presence of some micro-bubbles and/or ultrafine bubbles may confer some benefits to the liquid pesticide, although larger bubbles, and particularly coarse bubbles, are likely to come out of solution at a faster rate and thus reduce the dissolved gas concentration, thereby reducing the efficacy of the liquid pesticide composition compared to the addition of only bubbles within the size range of nano-bubbles. After the addition of nano-bubbles to the liquid stream, the liquid pesticide may preferably have greater than one billion nano-bubbles per milliliter of liquid pesticide dispersed in the liquid pesticide. The nano-bubble generator 18 may be designed for a liquid pesticide flow rate of up to 500 gpm, and optionally up to 1,000 gpm, and a gas flow rate of up to 80 cubic feet per hour at a pressure of 100 psig.

Once the liquid pesticide formulation with the nano-bubbles dispersed therein has been produced, the liquid pesticide may be applied to crops and to soil in which crops are grown in order to control pests for crop protection. The liquid may be applied broadly to both field crops and to the surface of the soil in a single application, and alternatively the liquid pesticide may also be applied subsurface to the soil. Without being bound by theory, that the addition of nano-bubbles to the liquid pesticide may result in increased efficacy and efficiency of the liquid pesticide due to a decrease in viscosity and surface tension of the liquid, which may allow for quicker entry of active ingredients into the plant cuticle as well as faster uptake. In addition, the nano-bubbles may help to stabilize the liquid pesticide formulation for pesticide mixtures, solutions, emulsions, or colloids by keeping the active ingredients in a suspended or dissolved state, as well as helping with liquid handling and application to crops and soils. Without being bound by theory, the addition of nano-bubbles to the liquid pesticide may aid in the mode of action of the active ingredients as well as improve the efficiency of the site of action delivery mechanism of the pesticide.

Herbicide Plot Trials Trials were conducted utilizing commercially available herbicides that were subsequently infused with nano-bubbles before application to weeds. The trials were conducted in August and September of 2021 in Winnsboro, Louisiana, USA. Three different herbicides were evaluated with each applied at two different application rates. The first herbicide evaluated is an herbicide sold under the trademark Liberty® (hereinafter referred to as “Liberty”) by BASF Ag Products, which contains 24.5% by weight of the active ingredient glufosinate-ammonium. The second herbicide evaluated is an herbicide sold under the trademark Engenia® (hereinafter referred to as “Engenia”) by BASF Ag Products, which contains 60.8% by weight of the active ingredient dicamba. The third herbicide evaluated is an herbicide sold under the trademark Roundup PowerMAX® (hereinafter referred to as “Roundup”) by Bayer CropScience, which contains the 48.7% by weight of the active ingredient glyphosate in the form of its potassium salt.

To evaluate the effect of nano-treated water on the efficacy of the herbicides relative to non-treated water, a triple replication field plot trial was conducted on both broadleaf and grassy weeds on randomized plots that were each 6.33 feet by 30 feet in area. Commercially available concentrated formulations of each herbicide were mixed with water to produce liquid pesticide that was then sprayed onto plots on which the weeds were growing. In some applications, each herbicide was mixed with non-treated water taken directly from a municipal water supply. In other applications, each herbicide was mixed with water that had previously been infused with nano-bubbles from a source of compressed ambient air so that the liquid herbicide formulation had a dissolved oxygen (DO) concentration of approximately 6 ppm by volume. Each concentrated herbicide was mixed with a volume of either non-treated water or nano-bubble treated water based on the label instructions for each herbicide to produce a full dosage of herbicide. In addition, some applications were also mixed with water to contain a one half (½) dosage of the herbicide concentrate based on the instructions. To this end, Liberty was tested at application rates of 16 fluid ounces per acre (oz/ac) of concentrated herbicide (half dosage) and 32 oz/ac (full dosage). Similarly, Engenia was tested at half and full dosage application rates of 6.4 oz/ac and 12.8 oz/ac. Roundup was tested at application rates of 12.8 oz/ac and 25.6 oz/ac. Control plots without any herbicide applied were also part of the trial.

No crop plants were present on any of the plots at the time of the trial. The type of soil at the trial site is classified as gigger silt loam and contains 70% silt, 16% clay, and 14% sand. The soil had a pH of 5.8 and a cation exchange capacity (CEC) of 5.8. The soil contained 1% organic matter (OM). The herbicides were applied to two different types of weeds. The first weed was a broadleaf weed, which was small flower morningglory, jacquemontia tamnifolia (hereinafter referred to as “IAQTA”). At application, this weed measured 4-10 inches in height with an average height of 8 inches. The second weed was a grassy weed, which was barnyard grass, echinochloa crus-gali (hereinafter referred to as “ECHCG”). At application, this weed measured 4-8 inches in height with an average height of 6 inches.

Both the full dosage and half dosage concentrations of each of the three herbicides were mixed with non-treated water and with nano-bubble treated water and applied to weeds on randomized plots. All herbicides were applied using a carbon dioxide (CO₂) powered backpack sprayer calibrated to spray at a liquid spray rate of 15 gallons per acre (GPA) at three miles per hour (mph) at a pressure of 35 psig. Each formulation was applied to three different randomized plots, and an average percentage of weed control on the three plots for each of the two weed types was recorded at three days after treatment (DAT), six DAT, and 16 DAT. Table 1 below shows the results of the trial. The applications that were treated with nano-bubbled water are indicated in Table 1 by the designation “NB.”

TABLE 1
Average percent of weed control from three trial plots treated with herbicides
mixed with non-treated water and with nano-bubble (NB) treated water.

| | Percent Weed Control | | Percent Weed Control | | Percent Weed Control | |
|---|---|---|---|---|---|---|
| | at 3 DAT (%) | | at 6 DAT (%) | | at 16 DAT (%) | |
| Pesticide | IAQTA | ECHCG | IAQTA | ECHCG | IAQTA | ECHCG |
| Control | 0 | 0 | 0 | 0 | 0 | 0 |
| Liberty | 93.3 | 80.7 | 95.3 | 86 | 96.3 | 76.7 |
| 16 oz/ac | | | | | | |
| Liberty NB | 94.7 | 83 | 96.3 | 95 | 96.3 | 81.7 |
| 16 oz/ac | | | | | | |
| Liberty | 94 | 83 | 97.7 | 95 | 99 | 89 |
| 32 oz/ac | | | | | | |
| Liberty NB | 97.7 | 85.7 | 99 | 97.7 | 99 | 97.7 |
| 32 oz/ac | | | | | | |
| Roundup | 38.3 | 16.7 | 70 | 63.3 | 81.7 | 80 |
| 12.8 oz/ac | | | | | | |
| Roundup NB | 50 | 20 | 58.3 | 68.3 | 75.7 | 86 |
| 12.8 oz/ac | | | | | | |
| Roundup | 48.3 | 25 | 76.7 | 80 | 93.3 | 96.3 |
| 25.6 oz/ac | | | | | | |
| Roundup NB | 53.3 | 28.3 | 75 | 82.3 | 95 | 96.3 |
| 25.6 oz/ac | | | | | | |
| Engenia | 60 | 0 | 58.3 | 0 | 70 | 10 |
| 6.4 oz/ac | | | | | | |
| Engenia NB | 66.7 | 0 | 68.3 | 8.3 | 78.3 | 10 |
| 6.4 oz/ac | | | | | | |
| Engenia | 70 | 3.3 | 70 | 3.3 | 81.7 | 10 |
| 12.8 oz/ac | | | | | | |
| Engenia NB | 73.3 | 0 | 68.3 | 13.3 | 90 | 23.3 |
| 12.8 oz/ac | | | | | | |

### Herbicide Plot Trial Results

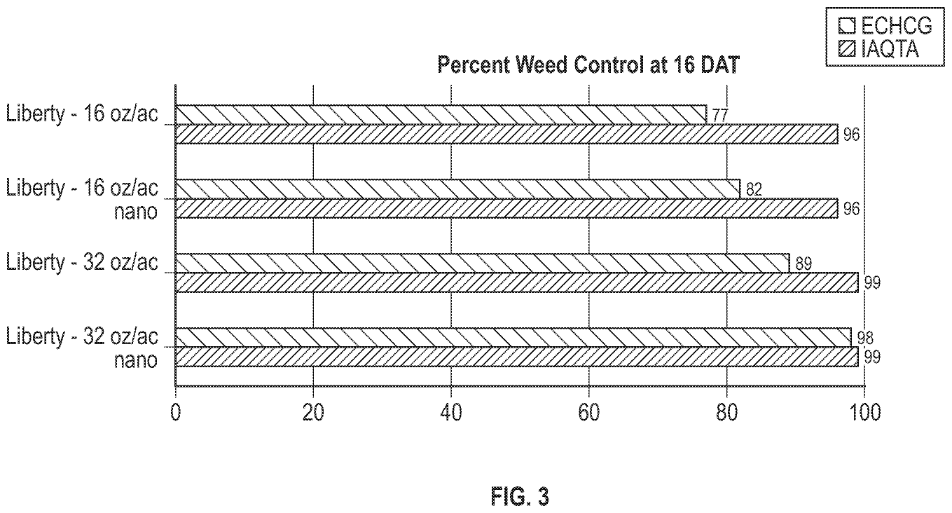

FIGS. 3-5 show a summary of the results at 16 DAT shown in Table 1. The percentage of weed control on each of the randomized plots, which indicates the percentage of weeds killed by a herbicide treatment, was determined utilizing analysis of variance (ANOVA) methodology by a third party tester.

As shown in FIG. 3, Liberty herbicide effectively controlled IAQTA, which is a broadleaf weed, at both full and half dosages and both with and without nano-bubble infusion at 16 DAT. In all applications, Liberty achieved an average of at least 96% weed control on IAQTA. It should be noted that Liberty is generally considered to be more effective on broadleaf weeds than on grassy weeds. When applied to ECHCG, which is a grassy weed, the nano-bubbled formulation of Liberty showed greater efficacy, particularly at the full dosage of 32 oz/ac, thus indicating the enhanced efficacy provided by nano-bubbling the liquid herbicide. The full dosage achieved 98% weed control of ECHCG with nano-bubbles compared to 89% weed control without nano-bubbles. At three DAT and six DAT, the difference in weed control between the Liberty formulation with and without nano-bubbles is not as significant as at 16 DAT, though the nano-bubbled formulation did show improvement in efficacy in each case and at each dosage, which may indicate that infusion of the liquid with nano-bubbles may be beneficial in enhancing long term weed control for the Liberty herbicide.

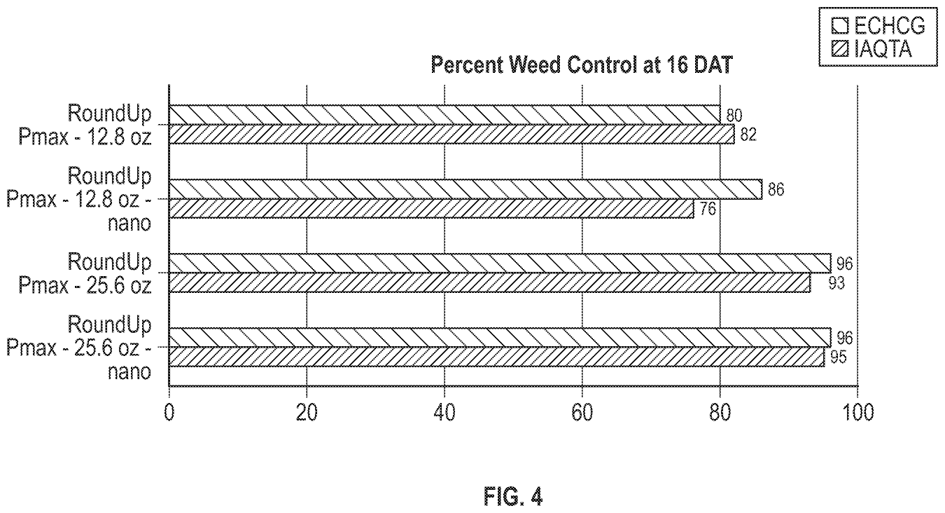

FIG. 4 shows the results for Roundup at 16 DAT. It should be noted that Roundup is generally considered to be more effective on grassy weeds, but is also generally effective on broadleaf weeds, as well, and is thus commonly used for both. As shown in FIG. 4, the nano-bubbled Roundup did not exhibit a significant increase in weed control at 16 DAT compared to the non-treated Roundup, though it did show a six percentage point increase on ECHCG at the half dosage. However, as shown in Table 1, at three DAT the nano-bubbled Roundup did show a significant increase in efficacy compared to the non-treated Roundup, particularly at the half dosage, which may indicate that that infusion of Roundup with nano-bubbles may speed up the weed killing process, which may improve the rainfast characteristics of Roundup. The efficacy of the half dosage at three DAT may also indicate increased activity of the Roundup herbicide at lower use rates.

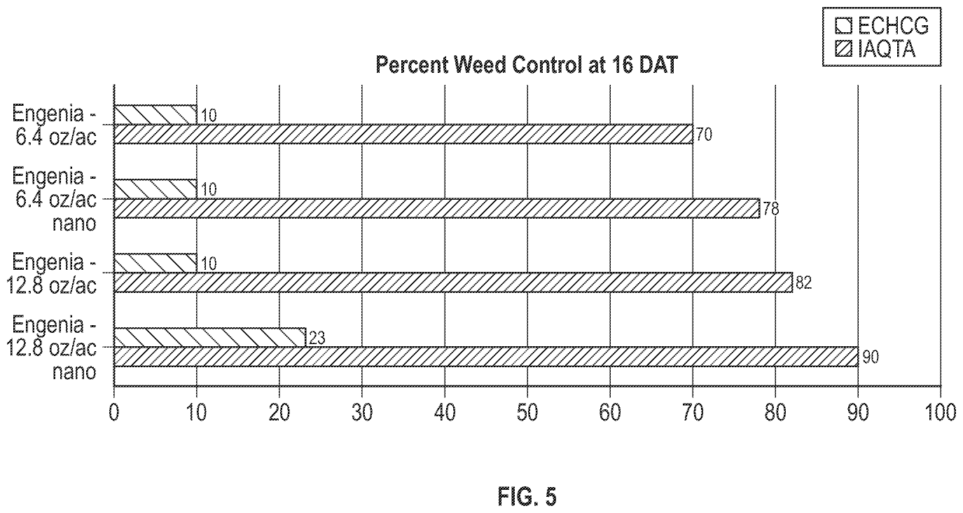

FIG. 5 shows the results for Engenia at 16 DAT. It should be noted that Engenia is generally used only for broadleaf applications and is generally not considered to be effective on grassy weeds, though some efficacy may be achieved on grassy weeds at high dosages. As shown in FIG. 5, Engenia is generally much more effective on the broadleaf IAQTA. FIG. 5 further shows that the nano-bubbled Engenia shows significant improvement in efficacy at both the half dosage and the full dosage. As shown in Table 1, even at three DAT Engenia is fairly effective against IAQTA, but shows practically no efficacy against the grassy weed ECHCG. However, as shown in FIG. 5 and in Table 1, at full dosage at both six DAT and at 16 DAT, the efficacy of Engenia is significantly enhanced by nano-bubbling the herbicide before application, which may indicate that infusion of Engenia with nano-bubbles may allow this herbicide to be used more broadly in applications in which it is desired to treat both broadleaf and grassy weeds while maintaining a reasonable level of efficacy against grassy weeds.

In total, the plot trials of the three herbicides on two types of weeds generally illustrates that nano-bubble treatment of the herbicides before application may enhance the efficacy of the herbicides, though the improvement in efficacy may depend on the specific type of herbicide, the dosage, and the time after application of the herbicide. Thus, characteristics of the efficacy improvement may vary depending on the particular herbicide being treated with nano-bubbles. The oxygen nano-bubble concentration in the plot trials for all herbicides was approximately 6 ppm by volume. A target concentration of 7-9 ppm by volume O₂ was desired but was not achieved in the trials. Achieving the target O₂ concentration would likely further enhance the efficacy of all tested herbicides.

### Bactericide Trials

Trials were conducted in a lab to evaluate the efficacy of bactericides infused with nano-bubbles as compared to conventional bactericides not treated with nano-bubbles. The trials were conducted utilizing commercially available bactericides that were subsequently infused with nan-bubbles before application to two different strains of bacteria, one of which was a copper tolerant strain of xanthomonas perforans (GEV 485) and one of which was a copper sensitive strain of xanthomonas perforans (91-118). The oxygen (O₂) nano-bubble concentration of all nano-bubbled bactericide applications was approximately 9 ppm O₂ by volume.

To conduct these trials, bacteria samples of each strain were taken from long term storage (−80° C.) and incubated on a nutrient agar (NA) medium (sold under the trademark Difco™ by Becton Dickinson and Co, MD) at 28° C. Bacteria were incubated on NA media containing 20 micrograms per milliliter (μg/ml) copper (II) sulfate pentahydrate (CuSOSO4·5H₂O) to induce copper resistance genes. Bacterial cells (24 hours) were suspended in 0.01M MgSO₄ (magnesium sulfate) in sterile deionized water and at OD_{600 nm} was adjusted to 0.3 (approximately 5×10 8 CFU/ml (colony-forming units per milliliter)) using a spectrophotometer. The bacterial suspension was diluted to 10⁵ CFU/ml in 0.01M MgSO4.

Nano bubbler water was sterilized using an autoclave at 121° C. for 20 minutes at 15 psig. Non-sterilized water was also used but due to population of other bacteria (contamination) being too high, bacteria population was not counted. A copper bactericide was prepared using both sterile nano-bubbled water and distilled water as follows:
1. Sterile nano-bubbled water was used to prepare a copper bactericide using a bactericide sold under the trademark Kocide® 3000-0 (hereinafter referred to as “Kocide” or “Kocide 3000”) by Certis USA, LLC. The bactericide was prepared with Kocide at concentrations of 100 μg/ml (0.33 g/liter), 500 μg/ml (1.67 g/liter), and 1000 μg/ml (3.33 g/liter) of Kocide mixed into sterile nano-bubbled water. Kocide 3000 contains 30% metallic copper in the form of copper hydroxide (46.1%). Sterile nano-bubbled water without Kocide served as control.
2. To compare conventional Kocide with Kocide mixed with nano-bubbled water, conventional formulations were also prepared at concentrations of 100, 500, and 1000 μg/ml of Kocide mixed with sterile 0.01 M MgSO₄ distilled water. Sterile 0.01 M MgSO₄ distilled water served as control.

For each treatment, 2 ml of each suspension were transferred to a sterile glass tube. Twenty microliters of bacterial suspension (10⁵ CFU/ml) were transferred to each glass tube to a final bacterial concentration of 10³ CFU/ml. Each treatment has three replications for both X. perforans strains (GEV 485 and 91-118). Glass tubes were incubated on a rotary shaker (200 rpm) at 28° C. To quantify bacterial populations, 50 μL from each tube were plated on NA after 15 minutes, 1 hour, 4 hours, and 24 hours of incubation. The plates were incubated for 48 hours at 28° C. Bacterial colonies formed on each plate were counted to calculate the CFU/ml. Bacteria populations (CFU/ml) were transformed to login for data presentation.

The results for both X. perforans strains (GEV 485 and 91-118) are shown in Tables 2 and 3 below, which show an average bacteria population of three replications each tested at four time intervals.

TABLE 2
Average bacteria population of copper-tolerant bacteria strain (GEV 485)
from three replications treated with bactericide of different concentrations
mixed with nano-bubble treated water and with deionized water.

| Materials | | Sterile Nano-Bubbled Water | | | | 0.01M MgSO₄ Deionized Water | | | |
|---|---|---|---|---|---|---|---|---|---|
| Conc. | | Control | Kocide | Kocide | Kocide | Control | Kocide | Kocide | Kocide |
| (ppm) | | (0 ppm) | (100) | (500) | (1000) | (0 ppm) | (100) | (500) | (1000) |
| 15 | min | 3.52 | 3.52 | 3.48 | 3.52 | 3.47 | 3.52 | 3.5 | 3.48 |
| 1 | hr | 3.49 | 3.3 | 3.51 | 3.52 | 3.49 | 3.49 | 3.5 | 3.48 |
| 4 | hr | 3.56 | 1.58 | 2.68 | 3.25 | 3.52 | 3.48 | 3.52 | 3.57 |
| 24 | hr | 4.9 | 1.08 | 0.44 | 2.8 | 5.0 | 2.77 | 3.41 | 3.34 |

TABLE 3
Average bacteria population of copper-sensitive bacteria strain (91-118)
from three replications treated with bactericide of different concentrations
mixed with nano-bubble treated water and with deionized water.

| Materials | | Sterile Nano-Bubbled Water | | | | 0.01M MgSO₄ Deionized Water | | | |
|---|---|---|---|---|---|---|---|---|---|
| Conc. | | Control | Kocide | Kocide | Kocide | Control | Kocide | Kocide | Kocide |
| (ppm) | | (0 ppm) | (100) | (500) | (1000) | (0 ppm) | (100) | (500) | (1000) |
| 15 | min | 3.47 | 2.27 | 2.57 | 2.48 | 3.49 | 2.88 | 2.77 | 2.52 |
| 1 | hr | 3.48 | 0 | 0 | 0 | 3.39 | 1.42 | 1.32 | 1.42 |
| 4 | hr | 3.38 | 0 | 0 | 0 | 3.18 | 0 | 0 | 0 |
| 24 | hr | 4.9 | 0 | 0 | 0 | 3.39 | 0 | 0 | 0 |

### Bactericide Trial Results

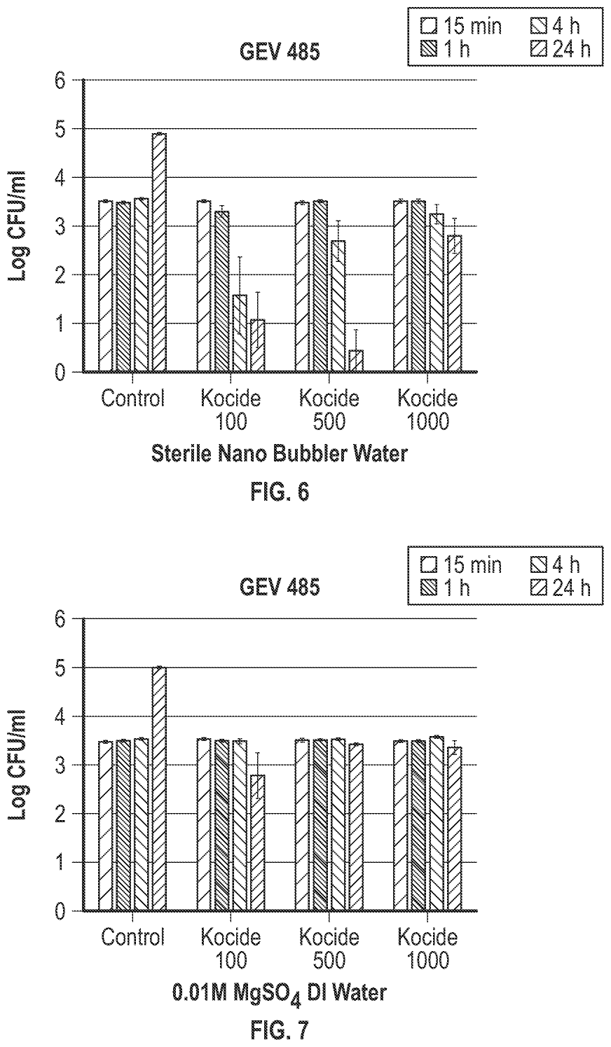

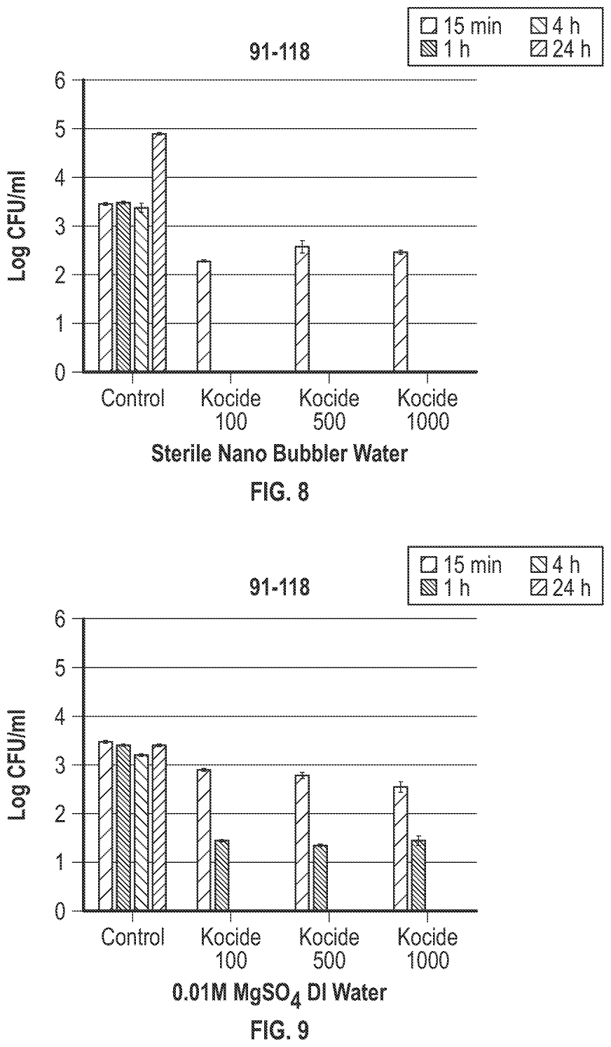

FIGS. 6-7 show a summary of the results shown in Table 2 for bacteria strain GEV 485, and FIGS. 8-9 show a summary of the results shown in Table 3 for bacteria strain 91-118.

As shown in FIGS. 6 and 7, the control samples showed steady bacteria population at 4 hours but showed significant bacteria growth at 24 hours without bactericide treatment. As shown in FIG. 7, Kocide formulated with deionized water did not show a significant decrease in bacteria population of the copper-tolerant GEV 485 strain at any concentration level even at 24 hours. However, as shown in FIG. 6, Kocide formulated with nano-bubbled water at bactericide concentrations of 100 ppm and at 500 ppm both showed a significant decrease in bacteria population of GEV 485 at 4 hours and particularly at 24 hours. It is noted that at the higher concentration of 1000 ppm there were small decreases in GEV 485 population at 4 hours and 24 hours but the decrease was not significant. Without being bound by theory, this may indicate that copper at high concentrations may interact with the nano-bubbles in the bactericide formulation in a manner that reduces the enhancing effect of the nano-bubbles on bactericide efficacy. In this case, copper-based bactericides may be effective at lower copper concentrations for certain strains of bacteria.

FIGS. 8 and 9 show results for bacteria strain 91-118, which is a copper-sensitive strain. As shown in FIG. 9, Kocide formulated with deionized water is very effective against strain 91-118 at one hour, and at 4 hours the bacteria population has been eliminated. However, as shown in FIG. 8, Kocide formulated with nano-bubbled water at all bactericide concentrations showed a slight increase in efficacy overall at 15 minutes but eliminated the entire bacteria population at one hour, thereby indicating that the nano-bubbles enhanced the efficacy of Kocide against the 91-118 strain at all bactericide concentrations.

It is understood that versions of the present disclosure may come in different forms and embodiments. Additionally, it is understood that one of skill in the art would appreciate these various forms and embodiments as falling within the scope of the invention as disclosed herein.

What is claimed is:

1) A method of treating crops, said method comprising the steps of:
providing a liquid pesticide;
providing a nano-bubble generator;
transferring nano-bubbles into the liquid pesticide using the nano-bubble generator so that the nano-bubbles are dispersed in the liquid pesticide, wherein the nano-bubbles have a mean diameter of less than 500 nanometers; and
applying the liquid pesticide having the nano-bubbles dispersed therein to crops or to soil in which the crops are grown.

2) The method of claim 1, wherein the step of transferring nano-bubbles into the liquid pesticide comprises transferring oxygen and nitrogen nano-bubbles from a compressed air source.

3) The method of claim 1, wherein the mean diameter of the nano-bubbles is less than 200 nanometers.

4) The method of claim 1, wherein the nano-bubbles comprise molecular oxygen.

5) The method of claim 1, wherein the nano-bubbles comprise ozone.

6) The method of claim 1, wherein the liquid pesticide has greater than one billion nano-bubbles per milliliter of liquid pesticide dispersed in the liquid pesticide.

7) The method of claim 1, wherein the step of applying the liquid pesticide having the nano-bubbles dispersed therein comprises applying the liquid pesticide to leaf tissue of the crops or to the surface of the soil.

8) A method comprising the steps of:
providing a liquid pesticide;
providing a nano-bubble generator; and
transferring nano-bubbles into the liquid pesticide using the nano-bubble generator so that the nano-bubbles are dispersed in the liquid pesticide, wherein the nano-bubbles have a mean diameter of less than 500 nanometers.

9) The method of claim 8, wherein the step of transferring nano-bubbles into the liquid pesticide comprises transferring oxygen and nitrogen nano-bubbles from a compressed air source.

10) The method of claim 8, wherein the step of transferring nano-bubbles into the liquid pesticide comprises flowing the liquid pesticide through the nano-bubble generator, and wherein flowing the liquid pesticide through the nano-bubble generator is the final step of the method before final packaging of the liquid pesticide.

11) The method of claim 8, wherein the step of providing the liquid pesticide comprises running the liquid pesticide through a high shear pump before transferring the nano-bubbles into the liquid pesticide.

12) The method of claim 11, wherein the step of providing the liquid pesticide further comprises adding pesticide compounds to a liquid carrier before running the liquid pesticide through the high shear pump.

13) The method of claim 8, wherein the mean diameter of the nano-bubbles is less than 200 nanometers.

14) The method of claim 8, wherein the nano-bubbles comprise molecular oxygen.

15) The method of claim 8, wherein the nano-bubbles comprise ozone.

16) The method of claim 8, wherein the liquid pesticide has greater than one billion nano-bubbles per milliliter of liquid pesticide dispersed in the liquid pesticide.

17) A liquid pesticide composition comprising:
a liquid pesticide having nano-bubbles dispersed therein,
wherein the nano-bubbles have a mean diameter of less than 500 nanometers.

18) The liquid pesticide of claim 17, wherein the mean diameter of the nano-bubbles is less than 200 nanometers.

19) The liquid pesticide of claim 17, wherein the nano-bubbles comprise molecular oxygen.

20) The liquid pesticide of claim 17, wherein the nano-bubbles comprise ozone.
